(19) United States
(12) Patent Application Publication
(10) Pub. No.: US 2023/0251422 A1
(43) Pub. Date: Aug. 10, 2023

(54) Optical Circuit

(71) Applicant: Nippon Telegraph and Telephone Corporation, Tokyo (JP)

(72) Inventors: Masashi Ota, Musashino-shi, Tokyo (JP); Keita Yamaguchi, Musashino-shi, Tokyo (JP); Osamu Moriwaki, Musashino-shi, Tokyo (JP); Kenya Suzuki, Musashino-shi, Tokyo (JP)

(21) Appl. No.: 18/005,278

(22) PCT Filed: Aug. 3, 2020
(86) PCT No.: PCT/JP2020/029662

§ 371 Date: Jan. 12, 2023

(51) Int. Cl. G02B 6/12

(52) U.S. Cl. CPC G02B 6/12033; G02B 6/12007

(57) ABSTRACT

An optical circuit including an optical waveguide including temperature compensation structure filled with a temperature compensation material, the optical circuit including adiabatic transition structure in which an optical wave propagating through the optical waveguide adiabatically transitions to the temperature compensation structure filled with the temperature compensation material.

### TECHNICAL FIELD

The present invention relates to an optical circuit by an embedded optical waveguide formed above a substrate, and more specifically, relates to an optical circuit including temperature compensation structure in which characteristics change of the optical circuit in relative to temperature change is compensated.

### BACKGROUND ART

Due to further increase in the capacity of wavelength multiplexing optical communication, research and development on silica-based planar lightwave circuits such as optical wavelength multiplexing and demultiplexing circuits and optical switch circuits supporting the wavelength multiplexing optical communication have been actively conducted. In many cases, components of these optical circuits include a plurality of optical signal paths having different optical path lengths and multiplexer and demultiplexer elements, and implement wavelength multiplexing and demultiplexing and switching functions using interference of optical waves.

Since interference characteristics of an optical wave depend on an optical path length difference between signal paths, and an effective refractive index for determining an optical path length has temperature dependence, conventionally, in order to keep transmission characteristics constant relative to temperature change, a groove of a waveguide has been filled with a temperature compensation material in which change in the effective refractive index due to temperature change has a change tendency different from that of a waveguide material.

In the prior art, the depth of the groove filled with the temperature compensation material is constant, and temperature compensation characteristics have been adjusted by the width of the groove and the type of the temperature compensation material being changed (Patent Literature 1 and Non Patent Literature 1). However, in a case where the groove has a shape penetrating a core layer, light has been scattered at the interface between the core layer and the groove particularly in a high-temperature or low-temperature environment, causing increase in optical loss.

### CITATION LIST

### Patent Literature

Patent Literature 1: JP 2009-265418 A

### Non Patent Literature

Non Patent Literature 1: S. Kamei, Y. Inoue, T. Shibata, A. Kaneko, “Low-Loss and Compact Silica-Based Athermal Arrayed Waveguide Grating Using Resin-Filled Groove” JOURNAL OF LIGHTWAVE TECHNOLOGY, VOL. 27, NO. 17, Sep. 1, 2009.

### SUMMARY OF INVENTION

In a conventional athermal (ATHERMAL: temperature independence, thermal compensation) optical circuit including a plurality of waveguides having different path lengths and multiplexing and demultiplexing structure, a groove filled with a temperature compensation material has been formed in a waveguide in order to widen a usable temperature region in a signal wavelength band, however, producing an optical circuit in which optical loss is reduced has been difficult due to limitations of processing and forming technique of the groove.

Furthermore, since temperature compensation characteristics have been determined only by the type of the temperature compensation material and the width of the groove, there has been an issue that, for example, scattering occurs at the interface between the waveguide clad and the groove particularly in a high-temperature or low-temperature environment, and wavelength dependence of transmission light intensity is deteriorated.

The present invention has been made to solve such issues, and an object thereof is to provide optical circuit structure that enables fine adjustment of temperature compensation characteristics.

According to the present invention, there is provided an optical circuit including temperature compensation structure in which an optical wave propagating through a waveguide adiabatically transitions to the temperature compensation structure and transmission characteristics are less deteriorated with low loss. Furthermore, the present invention provides optical circuit structure in which the temperature compensation structure is installed at a predetermined distance from a core of the waveguide, thereby enabling fine adjustment of the temperature compensation characteristics at least using parameters of the distance from the core and the width of the groove.

In order to achieve such an object, one embodiment of the present invention is an optical circuit including an optical waveguide including temperature compensation structure filled with a temperature compensation material, the optical circuit including adiabatic transition structure in which an optical wave propagating through the optical waveguide adiabatically transitions to the temperature compensation structure filled with the temperature compensation material.

In the temperature compensation structure of the optical circuit of the present invention described above, optical circuit structure in which temperature compensation characteristics can be finely adjusted while optical loss is reduced can be provided.

### BRIEF DESCRIPTION OF DRAWINGS

FIG. 1 is a top view (a) and a substrate cross-sectional view (b) in the longitudinal direction used for describing basics of temperature compensation structure of an optical circuit according to one embodiment of the present invention.

FIG. 2 is a top view (a), an enlarged top view (b), and a substrate cross-sectional view (c) used for describing the temperature compensation structure of the optical circuit according to the one embodiment of the present invention in a Mach-Zehnder interferometer optical circuit.

FIG. 3 is views illustrating two examples (a) and (b) of a substrate cross-sectional view in the lateral direction of the temperature compensation structure according to the one embodiment of the present invention.

FIG. 4 is a top view (a) and a substrate cross-sectional view (b) used for describing an example in which segment structure in which a plurality of segments is continuous is included as the temperature compensation structure of the optical circuit according to the one embodiment of the present invention.

FIG. 5 is a top view (a) and an enlarged substrate cross-sectional view (b) used for describing temperature compensation structure of an optical circuit according to another embodiment of the present invention in an American wire gauge (AWG).

FIG. 6 is a top view (a) and an enlarged substrate cross-sectional view (b) used for describing an example in which the temperature compensation structure according to the another embodiment of the present invention is provided in a slab waveguide in the AWG.

### DESCRIPTION OF EMBODIMENTS

Hereinafter, embodiments of the present invention will be described in detail with reference to the drawings.

### Basic Structure

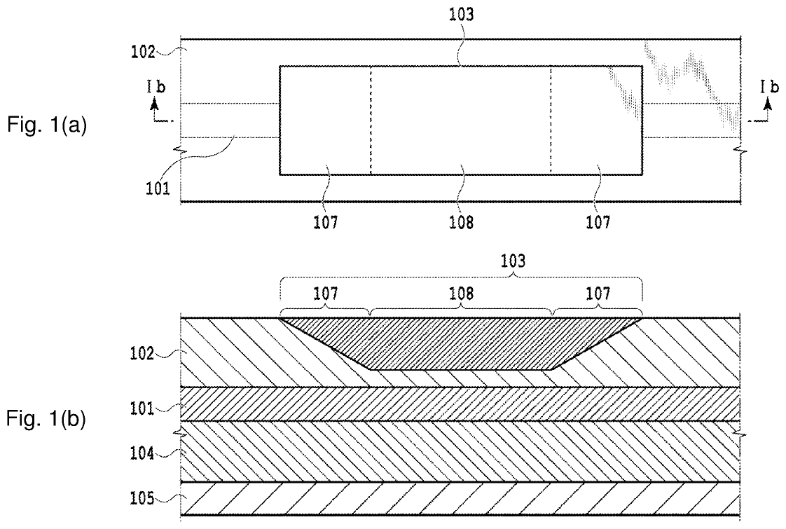

FIG. 1 is a top view (a) and a substrate cross-sectional view (b) in the longitudinal direction along propagation light passing through a core used for describing basic structure illustrating a concept of temperature compensation structure of an optical circuit according to the embodiments of the present invention.

In the top view of FIG. 1(a), propagation light incident from, for example, the left end of a core 101 embedded in an upper clad 102 of a chip of the optical circuit passes below temperature compensation structure 103 provided in the upper clad 102 of the core 101, and is emitted to the right end side after being temperature-compensated.

As illustrated in the substrate cross-sectional view of FIG. 1(b), the core 101 embedded between the upper clad 102 and a lower clad 104 is formed above a substrate 105 to form an optical waveguide of the optical circuit. A temperature compensation material fills a groove (depression, well) formed on the upper surface side of the upper clad 102 to form the temperature compensation structure 103.

On the incident side and the emission side of the temperature compensation structure 103, tapered portions 107 in which the thickness of the temperature compensation material gradually increases on the incident side and the thickness gradually decreases on the emission side are formed as adiabatic transition structure so that the thickness changes adiabatically (continuously without rapid change in the effective refractive index). The thickness change of the tapered portions 107 is linearly changed by way of example, but is not limited thereto, and is only required to be changed continuously as long as it satisfies an adiabatic condition in which optical loss is not caused. Using this adiabatic transition structure, optical loss due to the temperature compensation structure 103 can be reduced. In a central portion (temperature compensation portion) 108 of the temperature compensation structure 103, the thickness of the temperature compensation material is substantially constant, and the upper clad 102 between the core 101 and the temperature compensation material also has a constant thickness. By the thickness of the upper clad 102 in this portion being adjusted, the temperature compensation characteristics can be finely adjusted.

In the present invention, since the adiabatic transition structure in which an optical wave propagating through the optical waveguide of the optical circuit adiabatically transitions to the temperature compensation structure filled with the temperature compensation material is provided, the temperature compensation characteristics can be finely adjusted, and optical loss can be reduced.

### First Embodiment

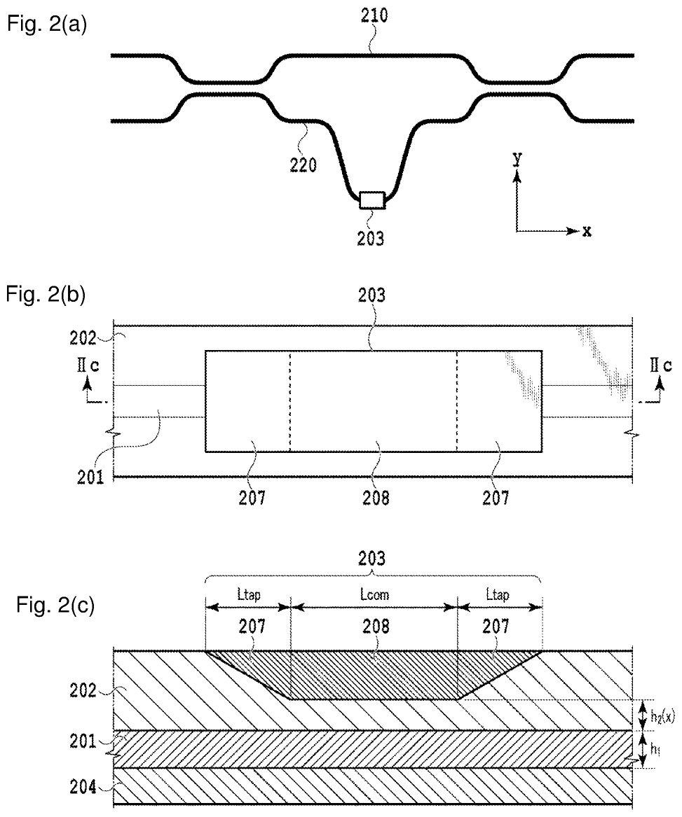

FIG. 2 illustrating a first embodiment of the present invention is a diagram illustrating an aspect in which temperature dependence of transmission characteristics is compensated via a temperature compensation structure in an optical circuit including a Mach-Zehnder interferometer including a first arm 210 and a second arm 220. Temperature compensation in the present embodiment will be described with reference to FIG. 2.

In FIG. 2(a), the Mach-Zehnder interferometer has structure in which the first arm 210 having a short optical path length and the second arm 220 having a long optical path length are branched on the incident side, and are multiplexed on the emission side. At this time, since the second arm has a larger value of an optical phase change amount due to effective refractive index change caused by change in environmental temperature, temperature compensation structure 203 is formed in the middle of the second arm 220.

FIG. 2(b) is an enlarged top view of the temperature compensation structure 203 of the second arm 220, and FIG. 2(c) is an enlarged substrate cross-sectional view in the longitudinal direction, and FIGS. 2(b) and 2(c) correspond to FIGS. 1(a) and 1(b). As illustrated in FIGS. 2(b) and 2(c), a core 201 embedded between an upper clad 202 and a lower clad 204 is formed above a substrate (not illustrated) to form an optical waveguide of the optical circuit. The temperature compensation material fills a groove (depression, well) formed on the upper surface side of the upper clad 202 to form the temperature compensation structure 203.

In the longitudinal direction substrate cross-sectional view of FIG. 2(c), the length in the waveguide direction of a central portion 208 in which the thickness of the temperature compensation material of the temperature compensation structure 203 is constant is defined as an interaction length Lcom, and the length of a tapered portion 207 is defined as Ltap. Furthermore, the thickness of the upper clad 202 from the bottom surface of the temperature compensation material of the central portion 208 of the temperature compensation structure 203 to the boundary surface between the upper clad 202 and the core 201 is defined as a distance h₂(x), and the thickness of the core 201 is defined as h₁. Note that x is a coordinate in the light propagation direction (left and right direction in FIG. 2(c) on the assumption that light propagates from left to right).

As illustrated in FIG. 2(c), the function h₂(x) gradually and continuously decreases adiabatically from the thickness of the upper clad 202 in a section of L_{com} of a tapered portion 207 on the left incident side, is set to a minimum value at the central portion 208, and is set to the minimum value h₂ over a section of the length Loom. Then, when light enters a section of Ltap of a tapered portion 207 on the right emission side, h₂(x) changes oppositely to gradually and continuously increase adiabatically. Because of the adiabatic change in light due to such adiabatic transition structure, temperature compensation characteristics can be finely adjusted by a structural parameter such as L_{com}, Ltap, and h₂ being adjusted while loss of light energy of propagation light is minimized, and optical loss due to the temperature compensation structure is reduced.

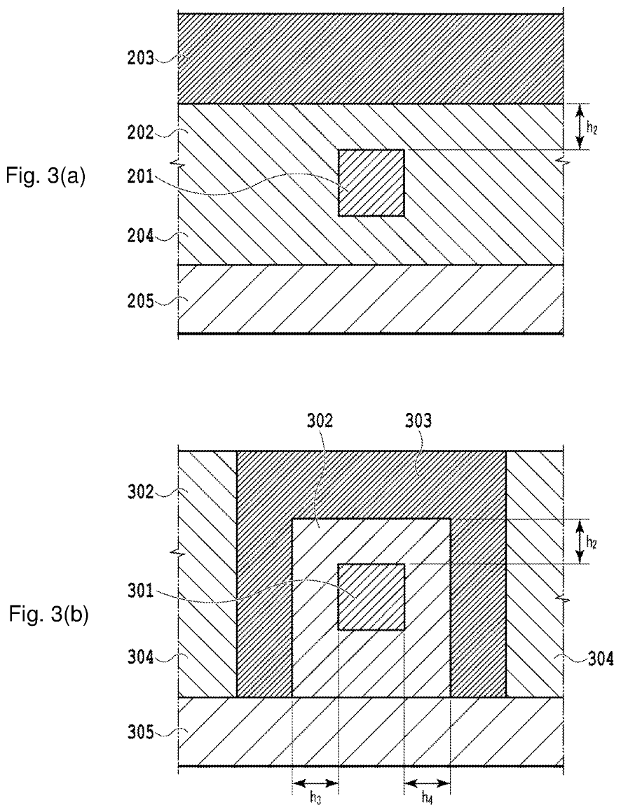

FIG. 3(a) illustrates a substrate cross-sectional view in the lateral direction of the temperature compensation structure of the optical circuit (substrate cross-sectional view of a plane perpendicular to the optical waveguide direction). The left and right direction in FIG. 3 corresponds to the y-axis direction in FIG. 2(a). The core 201 embedded in the upper clad 202 and the lower clad 204 is formed above the substrate 205, and the temperature compensation structure 203 is formed on the upper surface side of the upper clad.

The temperature compensation structure 203 includes the groove filled with the temperature compensation material, and a material having a refractive index change amount per unit temperature change dn/dT that is different from those of the core and clad materials and has a larger absolute value is selected as the temperature compensation material.

Here, the depth of the groove is different between the tapered portions 207 and the temperature compensation portion of the central portion 208, that is, in the tapered portions 207, the distance h₂(x) between the core 201 and the temperature compensation material changes adiabatically in the x-axis direction (changes continuously without optical loss), and is constant in the central portion 208 of the temperature compensation portion. By the distance h₂(x) between the core and the temperature compensation material being designed, the phase shift compensation amount per unit length can be finely adjusted.

Under a condition in which a clad layer is sufficiently thick, the change amount per unit temperature dn_{eff}/dT of the effective refractive index n_{eff} in the embedded optical waveguide can be expressed by following (Equation 1).

$$\begin{matrix}Math . 1 & \\ \frac{d {n}_{e f f}}{d T} = \frac{\partial {n}_{e f f}}{\partial {n}_{core}} \frac{d {n}_{c o r e}}{dT} + \frac{\partial {n}_{e f f}}{\partial {n}_{clad}} \frac{d {n}_{clad}}{d T} + {h}_{1} \frac{\partial {n}_{e f f}}{\partial {h}_{1}} {α}_{{h}_{1}} + w \frac{\partial {n}_{e f f}}{\partial w} {α}_{w} & ( Equation 1 )\end{matrix}$$

Here, T represents the environmental temperature, n_{core} represents the refractive index of the core, n_{clad} represents the refractive index of the clad, h₁ represents the height of the core, w represents the width of the core, αₕ₁ represents the linear expansion coefficient of h₁, and α_{w} represents the linear expansion coefficient of w (width direction).

The compensation amount per unit temperature change dn_{com}/dT of the effective refractive index n_{eff} in the temperature compensation portion of the temperature compensation structure formed in the second arm can be expressed by following (Equation 2).

$$\begin{matrix}Math . 2 & \\ \frac{{dn}_{com}}{DT} = \frac{\partial {n}_{eff}}{\partial {n}_{m}} \frac{{dn}_{m}}{dT} + {h}_{2} \frac{\partial {n}_{eff}}{\partial {h}_{2}} {α}_{{h}_{2}} & ( Equation 2 )\end{matrix}$$

Here, T represents the environmental temperature, nm represents the refractive index of the temperature compensation material, h₂ represents the distance between the core and the temperature compensation structure, w represents the width of the core, and αₕ₂ represents the linear expansion coefficient of h₂. Furthermore, h₂ is usually a positive value, but h₂ may be a negative value for the purpose of enhancing temperature compensation effect per unit propagation length. The negative value of h₂ can be realized by, for example, deepening the groove of the temperature compensation structure 203 to eliminate a portion of the upper clad 202 at the bottom of the groove and shaving the thickness of the core 201 or shaving the width of the core 201. In this case, the core 201 may be reduced in thickness or width by a predetermined value and in contact with the temperature compensation material. In a case where h₂ is a negative value, provided that the height h₁′ of the core is h₁+h₂, the compensation amount per unit temperature change dn_{com}/dT can be expressed by following (Equation 3).

$$\begin{matrix}Math . 3 & \\ \frac{d {n}_{com}}{dT} = \frac{\partial {n}_{eff}}{\partial {n}_{m}} \frac{d {n}_{m}}{d T} + {h}_{1}^{′} \frac{\partial {n}_{eff}}{\partial {h}_{1}^{′}} {α}_{{h}_{1}^{′}} & ( Equation 3 )\end{matrix}$$

In the tapered portions 207, since h₂ adiabatically changes along the propagation axis (x axis in the present embodiment) in the second term of (Equation 2) or (Equation 3), the phase shift compensation amount Δφₜₐₚ per unit temperature change can be expressed by following (Equation 4) or (Equation 5).

$$\begin{matrix}Math . 4 & \\ {Δφ}_{tap} = {k}_{0} {\int }_{0}^{{L}_{tap}} ( \frac{\partial {n}_{e f f}}{\partial {n}_{m}} \frac{d {n}_{m}}{d T} + {h}_{2} ( x ) \frac{\partial {n}_{e f f}}{\partial {h}_{2}} {α}_{{h}_{2}} ) dx & ( Equation 4 )\end{matrix}$$

$$\begin{matrix}Math . 5 & \\ {Δφ}_{tap} = {k}_{0} {\int }_{0}^{{L}_{tap}} ( \frac{\partial {n}_{eff}}{\partial {n}_{m}} \frac{d {n}_{m}}{dT} + {h}_{1}^{′} ( x ) \frac{\partial {n}_{eff}}{δ {h}_{1}^{′}} {α}_{{h}_{1}^{′}} ) dx & ( Equation 5 )\end{matrix}$$

Here, Lₜₐₚ is the length of a tapered portion 207, and k₀ is the wave number in vacuum. Furthermore, for the purpose of causing an optical signal to transition to the temperature compensation portion with low loss, the effective refractive index change amount in tapered portions is usually set to 0.1 or less per 1 μm of the propagation length.

In order to compensate for the phase shift change amount that change in the environmental temperature T gives to the optical path length difference ΔL between the first arm and the second arm, the compensation amount of the effective refractive index and the structural parameter are set such that the following conditional equation (Equation 6) holds.

$$\begin{matrix}Math . 6 & \\ \frac{d {n}_{e f f}}{d T} Δ L + \frac{d {n}_{c o m}}{d T} {L}_{c o m} + 2 \frac{{Δφ}_{tap}}{{k}_{0}} = 0 & ( Equation 6 )\end{matrix}$$

Provided that the reference environmental temperature used for circuit design is T₀ regarding (Equation 6), in order to compensate for high-order (up to N-th order) temperature characteristics, structure may be designed such that the following conditional equation (Equation 7) holds.

$$\begin{matrix}Math . 7 & \\ {\sum }_{i = 1}^{N} ( {A}_{i} Δ L + {B}_{i} {L}_{c o m} + {C}_{i} {L}_{tap} ) {( T - {T}_{0} )}^{i} = 0 & ( Equation 7 )\end{matrix}$$

Here, Aᵢ, Bᵢ, and Cᵢ are constants corresponding to i-th order temperature characteristics and temperature compensation.

In the first embodiment, Si is used as the material of the substrate, and α_{w} may be affected by thermal expansion of the substrate. Furthermore, in the first embodiment, the optical waveguide is formed from SiO₂, and the refractive index difference A between the core and the clad is set to approximately 1% by a refractive index adjusting material being added. In the first embodiment, the film thickness direction distance h₂ and the width direction distances h₃ and h₄ are usually values of 0.5 μm or less, and provided that h₂, h₃, and h₄ are negative values, that is, as long as a propagation mode exists, there is no lower limit on the value of the height h₁′ of the core. The refractive index of the temperature compensation material is adjusted to be the same value as that of the clad at a reference temperature at the time of circuit design. This is because scattering occurs as the refractive index difference between the core and the clad increases in addition to the temperature of the usage environment, and wavelength dependence of transmission light intensity deteriorates. By the refractive index difference between the core and the clad being reduced, deterioration of the wavelength dependence of the transmission light intensity can be reduced.

The above structure can be implemented by the thickness distribution of the upper clad being adjusted using a local etching device or the like after being manufactured by a normal optical circuit process.

FIG. 3(b) is a substrate cross-sectional view in the lateral direction of temperature compensation structure (substrate cross-sectional view of a plane perpendicular to the optical waveguide direction) in a case where the temperature compensation material fills up to the side surfaces of the waveguide in the first embodiment. In the substrate cross-sectional view in the lateral direction 3(b), a core 301 is surrounded by an upper clad 302 and a lower clad 304 and formed above a substrate 305, the upper surface and the side surfaces are covered with the temperature compensation material to form temperature compensation structure 303, and the core 301 is embedded in the upper 302 clad 302 and the lower clad 304.

Here, the film thickness direction distance h₂ and the width direction distances h₃ and h₄ between the core and the temperature compensation material have different values in the tapered portions and the temperature compensation portion, that is, in the tapered portions, they change adiabatically along the waveguide pattern, and are constant in the temperature compensation portion. Furthermore, the width direction distances are usually symmetrical and satisfy h₃=h₄, but in a case where a degree of freedom in designing an optical circuit pattern is required, different values may be set. By the film thickness direction distance h₂ and the width direction distances h₃ and h₄ (collectively referred to as a structural parameter) between the core and the temperature compensation material being designed, the phase shift compensation amount per unit length for each polarization mode can be further finely adjusted.

In a case where the waveguide cross section has structure of FIG. 3(b) in the present embodiment, the compensation amount per unit temperature change dn_{com}/dT of the effective refractive index n_{eff} in the temperature compensation portion of the temperature compensation structure formed in the second arm can be expressed by following (Equation 8).

$$\begin{matrix}Math . 8 & \\ \frac{d {n}_{c o m}}{d T} = \frac{\partial {n}_{e f f}}{\partial {n}_{m}} \frac{d {n}_{m}}{d T} + {h}_{2} \frac{\partial {n}_{e f f}}{\partial {h}_{2}} {α}_{{h}_{2}} + {h}_{3} \frac{\partial {n}_{e f f}}{\partial {h}_{3}} {α}_{{h}_{3}} + {h}_{4} \frac{\partial {n}_{e f f}}{\partial {h}_{4}} {α}_{{h}_{4}} & ( Equation 8 )\end{matrix}$$

In the tapered portions, since h₂, h₃, and h₄ change along the propagation axis (x axis in the present embodiment) in the second to fourth terms of (Equation 8), the phase shift compensation amount Δφₜₐₚ per unit temperature change can be expressed by following (Equation 9).

$$\begin{matrix}Math . 9 & \\ {Δφ}_{tap} = {k}_{0} {\int }_{0}^{{L}_{tap}} ( \frac{\partial {n}_{eff}}{\partial {n}_{m}} \frac{{dn}_{m}}{dT} + {h}_{2} ( x ) \frac{\partial {n}_{eff}}{\partial {h}_{2}} {α}_{{h}_{2}} + {h}_{3} ( x ) \frac{\partial {n}_{eff}}{\partial {h}_{3}} {α}_{{h}_{3}} + {h}_{4} ( x ) \frac{\partial {n}_{eff}}{\partial {h}_{4}} {α}_{{h}_{4}} ) dx & ( Equation 9 )\end{matrix}$$

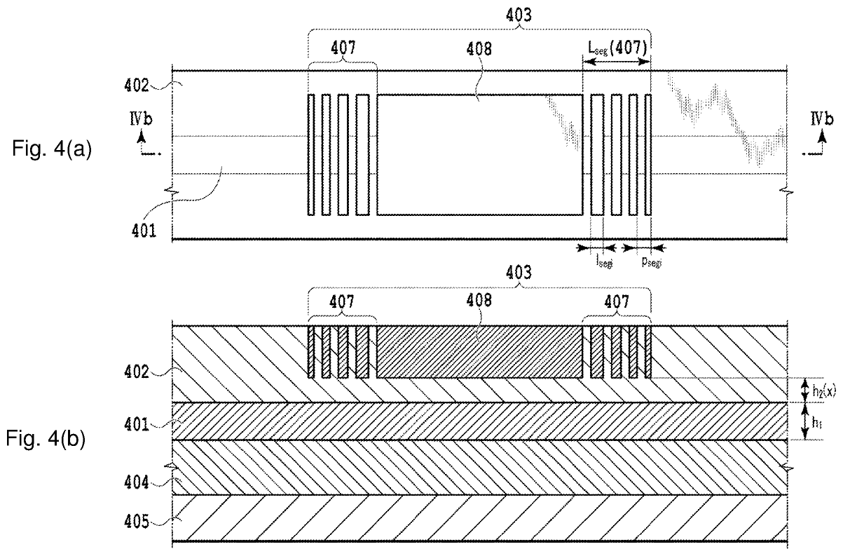

FIG. 4 illustrates an example in which segment structure 407 including a plurality of continuous segments (narrow groove structure in which the groove width of the i-th segment is l_{segi}) is used, instead of the above-described tapered structure, as structure in which an optical signal adiabatically transitions to the temperature compensation portion (adiabatic transition structure). As illustrated in FIGS. 4(a) and 4(b), a core 401 embedded between an upper clad 402 and a lower clad 404 is formed above a substrate 405 to form an optical waveguide of the optical circuit. The temperature compensation material fills a groove (depression, well) formed on the upper surface side of the upper clad 402 to form temperature compensation structure 403. In the temperature compensation structure 403, the segment structure 407 is formed on both sides of a central portion 408. The central portion 408 corresponds to the central portion 108 or 208. The cycle from a segment to the next segment in the segment structure 407 (including the groove width of the segment and the width of the next waveguide portion) is set as a pitch p_{segi}.

As illustrated in the substrate cross-sectional view of FIG. 4(b), in the segment structure 407, the distance h₂ in the thickness direction between the core and the segments is constant, and the ratio of the width to the pitch of each of the segments (so-called duty ratio l_{segi}/p_{segi}) changes adiabatically along the light propagation axis x direction.

Similarly to the case in which the tapered structure is used, for the purpose of causing an optical signal to transition to the temperature compensation portion with low loss, the effective refractive index change amount in segment portions is usually set to 0.1 or less per 1 μm of the propagation length.

In order to achieve adiabatic change, the ratio of the width to the pitch of each of the segments (duty ratio) is set as a structural parameter such that the average effective refractive index does not change suddenly but adiabatically change continuously.

The overall length L_{seg} of the segment structure 407 can be expressed by following (Equation 10) by the number N of the segments and the pitch pᵢ of the i-th segment being determined.

$$\begin{matrix}Math . 10 & \\ {L}_{s e g} = {k}_{0} {\sum }_{i = 1}^{N} {p}_{i} & ( Equation 10 )\end{matrix}$$

Furthermore, the phase shift compensation amount Δφ_{seg} per unit temperature change in the segment structure can be expressed by following (Equation 11).

$$\begin{matrix}Math . 11 & \\ {Δφ}_{seg} = {k}_{0} {\sum }_{i = 1}^{N} {\int }_{0}^{{l}_{s e g i}} ( \frac{\partial {n}_{eff}}{\partial {n}_{m}} \frac{d {n}_{m}}{dT} + {h}_{2} \frac{\partial {n}_{e f f}}{\partial {h}_{2}} {α}_{{h}_{2}} ) d x & ( Equation 11 )\end{matrix}$$

Here, l_{segi} represents the length of the i-th segment. The design parameter determination equations of the segment structure are established by φₜₐₚ and Lₜₐₚ in (Equation 4) to (Equation 6) being replaced with φ_{seg} and L_{seg}, respectively.

### Second Embodiment

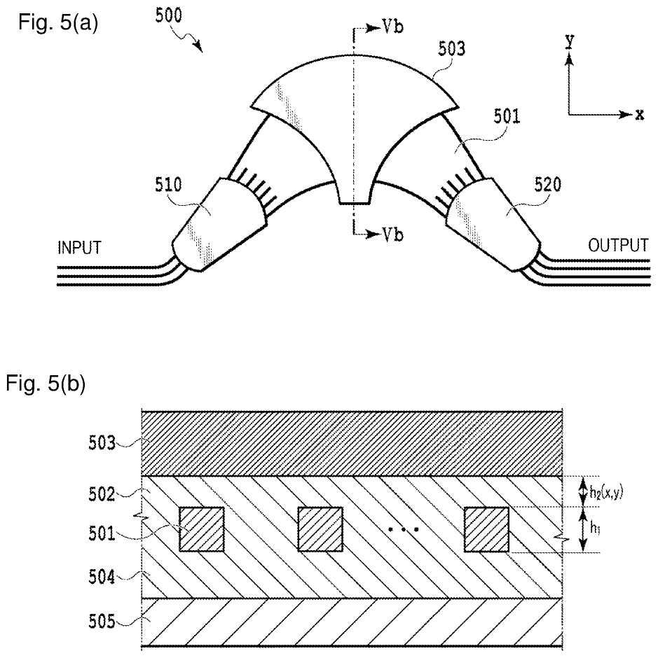

A second embodiment is an aspect in which temperature dependence of transmission characteristics is compensated via optical circuit structure in an arrayed waveguide diffraction grating type wavelength multiplexing and demultiplexing circuit (AWG) 500 including a slab waveguide 510 to which one or more input waveguides illustrated in FIG. 5 are connected, a slab waveguide 520 to which one or more output waveguides are connected, and M arrayed waveguides 501 that connect these two slab waveguides. Temperature compensation in the second embodiment will be described with reference to a plan view of FIG. 5(a) and a substrate cross-sectional view of a central portion of the arrayed waveguides 501 of FIG. 5(b). In the AWG 500, a plurality of cores of the arrayed waveguides 501 embedded in an upper clad 502 and a lower clad 504 is formed above a substrate 505, and temperature compensation structure 503 filled with a temperature compensation material is formed on the upper surface side of the upper clad 502.

In FIG. 5, the arrayed waveguides 501 include M waveguides having different lengths by ΔL. At this time, since an arrayed waveguide having a larger radius of curvature has a larger optical phase change amount due to the effective refractive index change caused by change in environmental temperature, the temperature compensation structure 503 is required to have a shape that provides a compensation amount corresponding to each arrayed waveguide.

In the plan view of FIG. 5(a), a planar shape of a fan shape that is wider upward is exemplified as the temperature compensation structure 503, but the actual shape changes according to a required compensation amount. FIG. 5(b) illustrates the substrate cross-sectional view in a cross section Vb-Vb of a central portion of the temperature compensation structure 503. It should be noted that the function of the distance in the thickness direction between the temperature compensation structure 503 and the cores of the arrayed waveguides 501 is determined by plane coordinates of FIG. 5(a), such as h₂(x,y).

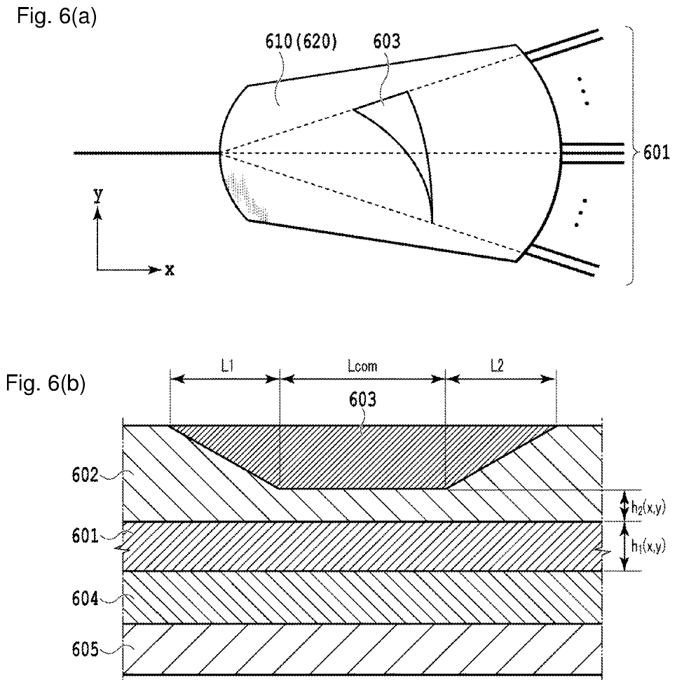

FIG. 6 illustrates a plan view (a) and a cross-sectional view (b) of optical circuit structure according to another example of the second embodiment. The optical circuit structure of the present example is an optical circuit concept in which temperature compensation structure is provided in the slab waveguide 510 or 520 included in the AWG described with reference to FIG. 5. In a slab waveguide 610 or 620, a core layer 601 of the slab waveguide 610 embedded in an upper clad layer 602 and a lower clad layer 604 is formed above a substrate 605, and temperature compensation structure 603 filled with the temperature compensation material is formed on the upper surface side of the upper clad layer 602. The slab waveguides 610 and 620 correspond to the slab waveguides 510 and 520 of FIG. 5, respectively. The core layer 601 of the slab waveguide 610 (or 620) is connected to one or more input waveguides (or output waveguides) and the core layer 601 of the arrayed waveguides. FIG. 6(b) is a cross-sectional view taken along a cross-sectional line connecting an input waveguide and one of the arrayed waveguides (dotted line illustrated in FIG. 6(a)). As illustrated in the cross-sectional view of FIG. 6(b), the temperature compensation structure 603 includes a groove formed in the upper clad layer 602 of the slab waveguide 610 or 620 of the AWG filled with the temperature compensation material.

As illustrated in the plan view of FIG. 6(a), the groove of the temperature compensation structure 603 are exemplarily illustrated as a curved triangle on light paths to the arrayed waveguides of the slab waveguide 610 or 620. As illustrated in the cross-sectional view of FIG. 6(b), the thickness of the upper clad layer 602 between the temperature compensation structure 603 filled with the temperature compensation material and the core layer 601 is constant over a section of a length Loom along the light propagation direction of a light path, and neighboring sections of lengths L1 and L2 are, for example, formed to be tapered as adiabatic transition structure portions.

In the second embodiment, similarly to the first embodiment, a material having a refractive index change amount per unit temperature change dn/dT that is different from those of the core and clad materials and has a larger absolute value is selected as the temperature compensation material that fills the temperature compensation structure 603. Furthermore, similarly to the first embodiment, in the temperature compensation structure 603, segment portions may be provided, as the adiabatic transition structure, neighboring to the temperature compensation structure 603 instead of the tapered portions. By the distance h₂ between the core layer 601 of the slab waveguide 610 or 620 and the temperature compensation structure 603 filled with the temperature compensation material being designed, the phase shift compensation amount per unit length can be finely adjusted.

The center transmission wavelength λ₀ of a center output port of the arrayed waveguide diffraction grating is determined by following (Equation 12).

$$\begin{matrix}Math . 12 & \\ {λ}_{0} = \frac{( {n}_{eff} + \frac{d {n}_{e f f}}{d T} Δ T ) Δ L}{m} & ( Equation 12 )\end{matrix}$$

Here, m represents the order of diffraction, and ΔT represents T−T₀. Therefore, by the temperature compensation structure being designed such that (Equation 6) holds for each arrayed waveguide, an athermal wavelength multiplexing and demultiplexing circuit can be designed. A determination equation of an optical circuit structure parameter for the i-th arrayed waveguide from the shortest optical path length is expressed by following (Equation 13).

$$\begin{matrix}Math . 13 & \\ \frac{d {n}_{e f f}}{d T} ( i - 1 ) Δ L + \frac{d {n}_{com}}{d T} {L}_{c o m} + 2 \frac{{Δφ}_{tap}}{{k}_{0}} = C & ( Equation 13 )\end{matrix}$$

Here, C is any constant and is usually 0, but for the purpose of making loss in the arrayed waveguide constant, an offset value may be set, for example, by tapered portions or segment portions of the temperature compensation structure being inserted into the arrayed waveguide of i=1.

Furthermore, the above-described function may be implemented by a slab waveguide instead of an arrayed waveguide. As illustrated in FIG. 6(b), in a case where the temperature compensation structure is formed in a slab waveguide, since power density is different in the neighboring portions of the temperature compensation structure, different taper lengths may be set on the input side and the output side.

The above structure can be formed by a method similar to the method described in the first embodiment.

### INDUSTRIAL APPLICABILITY

As described above, in the optical circuit of the present invention, optical circuit structure in which temperature compensation characteristics can be finely adjusted while optical loss is reduced can be provided.

1. An optical circuit comprising an optical waveguide comprising temperature compensation structure filled with a temperature compensation material, the optical circuit comprising adiabatic transition structure in which an optical wave propagating through the optical waveguide adiabatically transitions to the temperature compensation structure filled with the temperature compensation material.

2. The optical circuit according to claim 1, further comprising, as the adiabatic transition structure, tapered structure in which a thickness of the temperature compensation material continuously changes.

3. The optical circuit according to claim 1, further comprising, as the adiabatic transition structure, structure in which duty ratio of segment structure comprising continuation of a plurality of segments continuously changes.

4. The optical circuit according to claim 1, wherein a core of the optical waveguide and the temperature compensation material are separated by a predetermined distance.

5. The optical circuit according to claim 1, wherein, in the temperature compensation structure, a thickness or a width of a core of the optical waveguide is reduced by a predetermined value, and a core of the optical waveguide and the temperature compensation material are in contact with each other.

6. The optical circuit according to claim 1, wherein a temperature compensation amount per unit length can be adjusted by designing a distance between a core of the optical waveguide and the temperature compensation material.

7. The optical circuit according to claim 2, wherein a core of the optical waveguide and the temperature compensation material are separated by a predetermined distance.

8. The optical circuit according to claim 3, wherein a core of the optical waveguide and the temperature compensation material are separated by a predetermined distance.

9. The optical circuit according to claim 2, wherein, in the temperature compensation structure, a thickness or a width of a core of the optical waveguide is reduced by a predetermined value, and a core of the optical waveguide and the temperature compensation material are in contact with each other.

10. The optical circuit according to claim 3, wherein, in the temperature compensation structure, a thickness or a width of a core of the optical waveguide is reduced by a predetermined value, and a core of the optical waveguide and the temperature compensation material are in contact with each other.

11. The optical circuit according to claim 2, wherein a temperature compensation amount per unit length can be adjusted by designing a distance between a core of the optical waveguide and the temperature compensation material.

12. The optical circuit according to claim 3, wherein a temperature compensation amount per unit length can be adjusted by designing a distance between a core of the optical waveguide and the temperature compensation material.

13. The optical circuit according to claim 4, wherein a temperature compensation amount per unit length can be adjusted by designing a distance between a core of the optical waveguide and the temperature compensation material.

14. The optical circuit according to claim 5, wherein a temperature compensation amount per unit length can be adjusted by designing a distance between a core of the optical waveguide and the temperature compensation material.
